(19) United States
(12) Patent Application Publication
(10) Pub. No.: US 2024/0223952 A1
(43) Pub. Date: Jul. 4, 2024

(54) DIAPHRAGM MANUFACTURING METHOD AND DIAPHRAGM

(71) Applicant: Panasonic Intellectual Property Management Co., Ltd., Osaka (JP)

(72) Inventor: Hidetoshi HIRAOKA, Kyoto (JP)

(73) Assignee: Panasonic Intellectual Property Management Co., Ltd., Osaka (JP)

(21) Appl. No.: 18/396,004

(22) Filed: Dec. 26, 2023

(30) Foreign Application Priority Data
Dec. 28, 2022 (JP) 2022-212078

(51) Int. Cl. H04R 7/02

(52) U.S. Cl. CPC H04R 7/02

(57) ABSTRACT

A diaphragm manufacturing method includes: when a pulp slurry obtained after beating of a pulp exhibits anionic predominance, adding a fluoropolymer that is cationic into the pulp slurry to cause the fluoropolymer to be contained in the pulp; and screening and shaping the pulp slurry into a diaphragm.

### CROSS REFERENCE TO RELATED APPLICATION

The present application is based on and claims priority of Japanese Patent Application No. 2022-212078 filed on Dec. 28, 2022.

### FIELD

The present disclosure relates to a method of manufacturing a diaphragm to be used in various audio devices and to the diaphragm.

### BACKGROUND ART

Conventionally, as described in Patent Literature (PTL) 1 and 2, there is a technique of adding a fluororesin to pulp slurry prior to screening (in papermaking) and causing the fluororesin to be contained in the pulp by using aluminum sulfate to thereby provide water-repellency to a diaphragm after screening. Furthermore, there is a technique of impregnating a diaphragm after screening with a solvent containing a fluororesin to provide water-repellency to the diaphragm.

### CITATION LIST

### Patent Literature

PTL 1: Japanese Patent No. 3036198
PTL 2: Japanese Patent No. 3084925

### SUMMARY

However, the diaphragms described in PTL 1 and 2 described above can be improved upon.

The present disclosure provides a diaphragm manufacturing method and a diaphragm that are capable of improving upon the above related art.

A diaphragm manufacturing method according to an aspect of the present disclosure includes: when a pulp slurry obtained after beating of a pulp exhibits anionic predominance, adding a fluoropolymer that is cationic into the pulp slurry to cause the fluoropolymer to be contained in the pulp; and screening and shaping the pulp slurry into a diaphragm.

A diaphragm manufacturing method according to an aspect of the present disclosure includes: when a pulp slurry obtained after beating of a pulp exhibits cationic predominance, adding a fluoropolymer that is anionic into the pulp slurry to cause the fluoropolymer to be contained in the pulp; and screening and shaping the pulp slurry into the diaphragm.

A diaphragm according to an aspect of the present disclosure includes: a pulp in which an acrylic resin is contained, the acrylic resin including a perfluoroalkyl terminal including at least 1 and at most 6 carbon atoms.

A diaphragm manufacturing method and a diaphragm according to the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a process chart illustrating a manufacturing process of a diaphragm according to the papermaking method.

FIG. 2 is a diagram schematically illustrating pulp having a predominantly anionic surface in a slurry.

FIG. 3 is a diagram schematically illustrating pulp having a predominantly cationic surface in a slurry.

FIG. 4 is a cross-sectional view of a diaphragm made from pulp in which a fluoropolymer is contained as a result of the addition of a cationic fluoropolymer.

FIG. 5 is a cross-sectional view of a diaphragm made from pulp in which a fluoropolymer is contained as a result of the addition of an anionic fluoropolymer.

FIG. 6 is a cross-sectional view of a loudspeaker device which is one example of an electroacoustic transducer.

FIG. 7 is a cross-sectional view of a car which is one example of a mobile body to which a loudspeaker device including the diaphragm is attached.

FIG. 8 is a diagram illustrating another usage example of a loudspeaker device including the diaphragm.

### DESCRIPTION OF EMBODIMENTS

Hereinafter, exemplary embodiments of a diaphragm manufacturing method, a diaphragm, and an electroacoustic transducer according to the present disclosure will be described with reference to the Drawings. It should be noted that each of the subsequent embodiments shows an example for describing the present disclosure, and thus is not intended to limit the present disclosure. For example, the shapes, structures, materials, structural components, the relative positional relationships and connections of the structural components, numerical values, formulas, steps, the processing order of the steps, and so on, shown in the following embodiments are mere examples, and details not described below may be included. Furthermore, although there are cases where geometric expressions, such as “parallel” and “orthogonal”, are used, these expressions are not mathematically precise indications and include substantially permissible error, deviation, and the like. Moreover, expressions, such as “simultaneous” and “identical (or the same)”, are considered to cover a substantially permissible range of meaning.

Additionally, the drawings are schematic illustrations that may include emphasis, omission, or adjustment of proportion as necessary for the purpose of describing the present disclosure, and thus the shapes, positional relationships, and proportions shown may be different from actuality. Furthermore, the X-axis, Y-axis, and Z-axis which may be shown in the drawings are arbitrarily set rectangular coordinates for describing the figures. In other words, the Z-axis is not limited to an axis in the vertical direction, and the X-axis and Y-axis are not limited to being axes inside a horizontal plane.

Furthermore, hereinafter, multiple inventions may be comprehensively described as a single embodiment. Moreover, part of the contents in the description below is described as an optional element related to the present disclosure.

The inventor has found that since conventional fluororesin does not have an ionic group and is not drawn to pulp in water, only a very small amount of fluororesin is contained (i.e., stays or settles) in the pulp after the water is drained, and thus a water-repelling effect after screening is hardly obtained. Furthermore, the inventor has found that, with the method of fluororesin-impregnating a diaphragm after screening, the weight of the diaphragm after impregnation is increased thereby affecting sound quality, and the solvent used during impregnation affects the environment.

The present disclosure provides a diaphragm manufacturing method, a diaphragm, and an electroacoustic transducer including the diaphragm, that are capable of effectively producing a water-repelling effect without having to fluororesin-impregnate the diaphragm after screening.

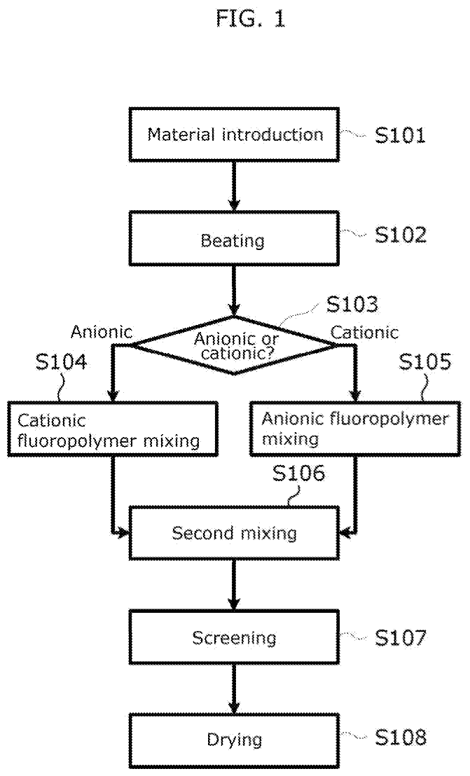

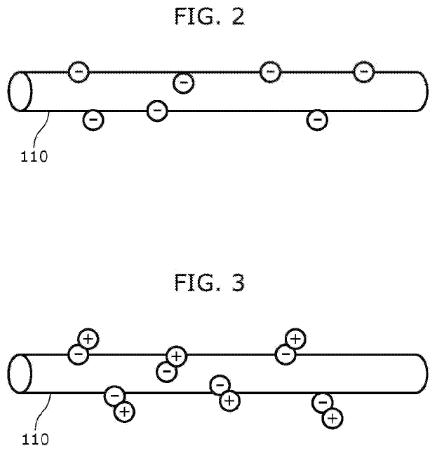

FIG. 1 is a process chart illustrating the manufacturing process of diaphragm 100 according to the papermaking method. FIG. 2 is a diagram schematically illustrating pulp 110 having a predominantly anionic surface in a slurry. FIG. 3 is a diagram schematically illustrating pulp 110 having a predominantly anionic surface in a slurry.

As a material of diaphragm 100, wood-derived pulp 110, which is wood-derived kraft pulp, is introduced inside a beater containing water (material introduction step: S101). Next, pulp 110 introduced in the material introduction step (S101) is finely beaten to a desired state (beating process: S102). In this embodiment, only mechanical beating is performed. Since only mechanical beating is employed, the use of solvents, and the like, that are harmful to the environment can be reduced.

It should be noted that at least one of long fiber pulp, recycled cotton fiber and recycled synthetic fiber that are hard resin coated, glass fiber, acrylic fiber, polyolefin fiber, polyester fiber, aramid fiber, or liquid-crystal polymer fiber may be added to wood-derived pulp 110 at least before or after beating. Adding long fiber pulp, synthetic fiber, and the like, makes it possible to stiffen diaphragm 100. Specific examples of long fiber pulp include non-wood pulp such as abaca pulp, ganpi, mitsumata, kozo, bagasse, bamboo, and so on. Recycled synthetic fiber is, for example, fiber obtained by pulverizing the sound-proofing material provided in an outdoor unit of an air conditioner to a length of about 1 mm to 10 mm and removing foreign objects. Some recycled synthetic fibers include cotton fiber and synthetic fiber that are coated with hard resin such as phenolic resin, and the like.

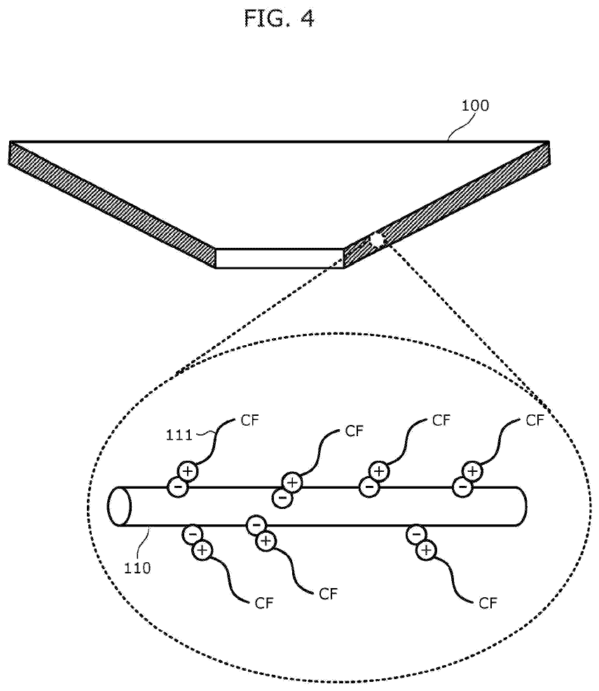

Next, when the pulp slurry obtained through the beating step (S102) exhibits anionic predominance, that is, when the OH group in the surface of pulp 110 in the pulp slurry is predominantly anionic as illustrated in FIG. 2 (anionic in S103), cationic fluoropolymer 111 (see FIG. 4) is added to the pulp slurry as a first mixing step (S104). In this embodiment, cationic fluoropolymer 111 includes a perfluoroalkyl terminal including at least 1 and at most 6 carbon atoms. Furthermore, cationic fluoropolymer 111 is an acrylic resin having a nitrogen-containing cationic group.

It should be noted that, when the OH group in the surface of pulp 110 in the pulp slurry is predominantly anionic (anionic in S103), it is also possible to add an anionic fluoropolymer. In such a case, subsequently adding a cationic fixing agent, such as aluminum sulfate, an amine-based cationic resin, an amide-based cationic resin, and so on, causes the anionic fluoropolymer to be contained in pulp 110.

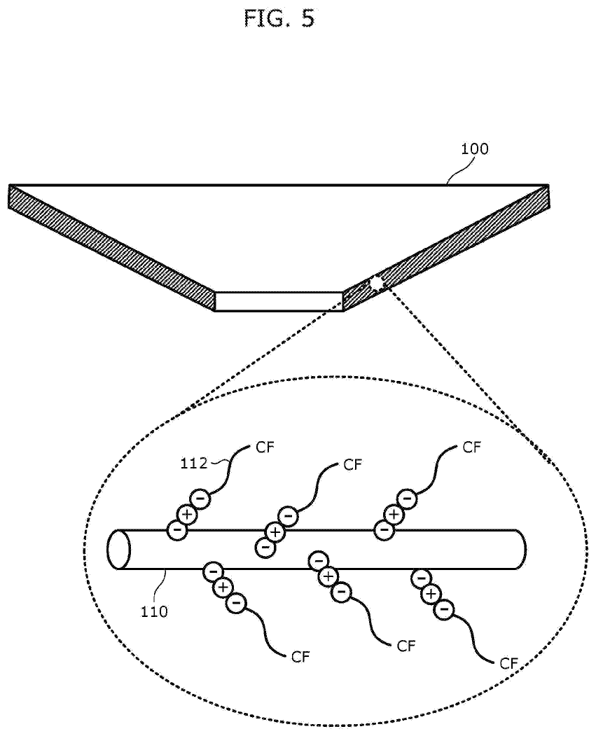

On the other hand, when the adding of a cationic fixing agent, such as aluminum sulfate, an amine-based cationic resin, or an amide-based cationic resin, before anionic fluoropolymer causes the pulp slurry to exhibit cationic predominance, that is, when the OH group in the surface of pulp 110 in the slurry becomes predominantly cationic, as illustrated in FIG. 3, due to the fixing agent, and so on, attaching itself to the OH group (cationic in S103), anionic fluoropolymer 112 (see FIG. 5) is added to the pulp slurry as a first mixing step (S105). In this embodiment, anionic fluoropolymer 112 includes a perfluoroalkyl terminal including at least 1 and at most 6 carbon atoms. Furthermore, anionic fluoropolymer 112 is an acrylic resin having an anionic group.

Next, a paper strengthening agent is mixed in (second mixing step: S106). Examples of a paper strengthening agent include a polyacrylamide-based paper strengthening agent or a polyamide epichlorohydrin-based paper strengthening agent. By adding a paper strengthening agent, a stiff diaphragm 100 can be manufactured without having to resin-impregnate diaphragm 100 after screening.

It should be noted that, although referred to as a first mixing step and a second mixing step, these expressions do not define the order of mixing, and merely indicate that a different type of additive is mixed in. Furthermore, the order indicated in the process chart is not limited to such, and the first mixing step and the second mixing step may be executed in reverse order or simultaneously. Moreover, since the paper strengthening agent may inhibit cationic fluoropolymer 111 from being contained in pulp 110, the paper strengthening agent may be added after the mixing of cationic fluoropolymer 111.

Next, the mixed slurry obtained through the mixing steps is shaped (formed) into diaphragm 100 as illustrated in FIG. 4 and FIG. 5 by screening the slurry on a mould of a specified shape and a wire net disposed above the mould and draining only the moisture by suctioning from below, according to the papermaking method (screening step: S107). At this point, since wood-derived pulp 110 has relatively short pulp length and relatively small (fine) pulp diameter, dispersibility during screening is high, and thus diaphragm 100 having high uniformity and excellent texture can be manufactured. It should be noted that, even if long fiber pulp, synthetic fiber, or the like, is mixed in with wood-derived pulp 110, wood-derived pulp 110 fills the gaps between the other type of pulp, and thus the uniformity of diaphragm 100 can be enhanced.

Next, the moisture included in diaphragm 100 formed through the screening process (S107) is evaporated and dried by heating and pressing (drying step: S108). Since long fiber pulp such as abaca pulp has relatively long pulp length and relatively small pulp diameter compared to wood-derived pulp 110, entanglement between fibers is strong, and thus diaphragm 100 can be stiffened, which contributes to the enhancement of sound quality of the electroacoustic transducer that includes diaphragm 100.

It should be noted that, with diaphragm 100 obtained by screening and shaping the above-described pulp slurry, even without performing impregnation with water repellent, the desired water-repelling performance is realized by cationic fluoropolymer 111 connected to the OH group in the surface of pulp 110 (see FIG. 4) or anionic fluoropolymer 112 connected to the OH group in the surface of pulp 110 via cations connected to the OH group in the surface of pulp 110 (see FIG. 5). Accordingly, the increase in the weight of diaphragm 100 due to water repellent impregnation can be eliminated, and thus a lightweight diaphragm 100 can be provided.

Diaphragm 100 manufactured according to the above-described method of manufacturing diaphragm 100 has, as a main material, pulp 110 in which an acrylic resin including a perfluoroalkyl terminal including at least 1 and at most 6 carbon atoms is contained. Accordingly, a large amount of fluorine is disposed in the surface of pulp 110 which is intricately entangled, and thus high water repellency can be achieved. In other words, diaphragm 100 according to the forgoing embodiment can achieve higher water repellency than a diaphragm that is formed by adding a fluororesin to a pulp slurry prior to screening. By using an acrylic resin that includes a perfluoroalkyl terminal including at least 1 and at most 6 carbon atoms, environmental harm can be reduced, stiffness, lightness, and high elasticity can be realized, and high acoustic performance can be achieved while reducing or eliminating the use of agents that harm the environment.

It should be noted that, in this embodiment, diaphragm 100 is exemplified by a cone-type diaphragm, but the shape of diaphragm 100 is not limited and may be rectangular, elliptic, and so on, in a plan view. Furthermore, the shape of diaphragm 100 need not be three-dimensional, and may be a flat shape.

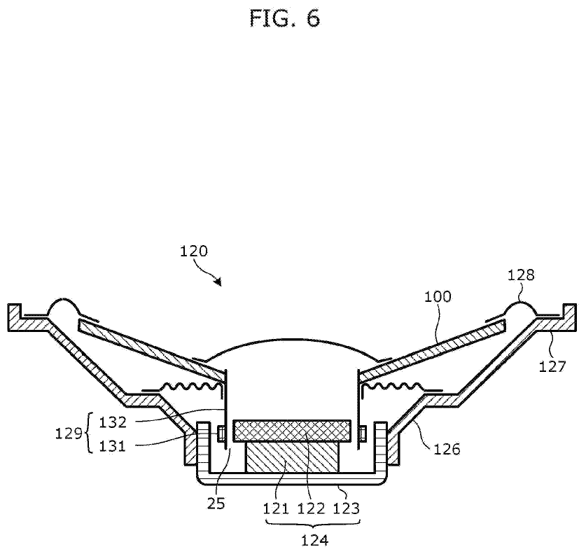

FIG. 6 is a cross-sectional view of loudspeaker device 120 which is one example of an electroacoustic transducer. As shown in FIG. 6, loudspeaker device 120 includes diaphragm 100, magnetic circuit 124, frame 126 that holds magnetic circuit 124 and diaphragm 100, and voice coil 131 that is connected to diaphragm 100 and disposed in the magnetic gap of magnetic circuit 124.

In this embodiment, magnetic circuit 124 included in loudspeaker device 120 consists of an inner magnetism type magnetic circuit in which magnetized magnet 121 is sandwiched between upper plate 122 and yoke 123.

Yoke 123 of magnetic circuit 124 is connected to frame 126. Loop-shaped edge 128 that connects an outer circumferential edge of diaphragm 100 and frame 126 is bonded to peripheral edge portion 127 of frame 126. The central portion of diaphragm 100 is connected to one end of voice coil body 129. The other end of voice coil body 129 is disposed to fit in magnetic gap 125 of magnetic coil 124. It should be noted that, in this embodiment, voice coil body 129 is exemplified as including voice coil 131 and bobbin 132 around which voice coil 131 is wound. However, it is also acceptable to have voice coil 129 that does not include bobbin 132.

Moreover, although loudspeaker device 120 including inner magnetism type magnetic coil 124 is described, the present disclosure is not limited to such, and diaphragm 100 may be applied to loudspeaker device 120 having an outer magnetism type magnetic circuit.

With above-described loudspeaker device 120, it is possible to realize a loudspeaker device having excellent characteristics and excellent sound quality. In particular, with diaphragm 100 manufactured according to the above-described manufacturing method, light weight and high rigidity are achieved without the inclusion of an impregnation step, and thus it is possible to realize an improvement in the upper limit frequencies in the characteristics of loudspeaker device 120.

Furthermore, with regard to the sound quality of loudspeaker device 120, the improvement in the lightness and rigidity of diaphragm 100 enables high fidelity reproduction and makes it possible to realize sound quality with high clarity.

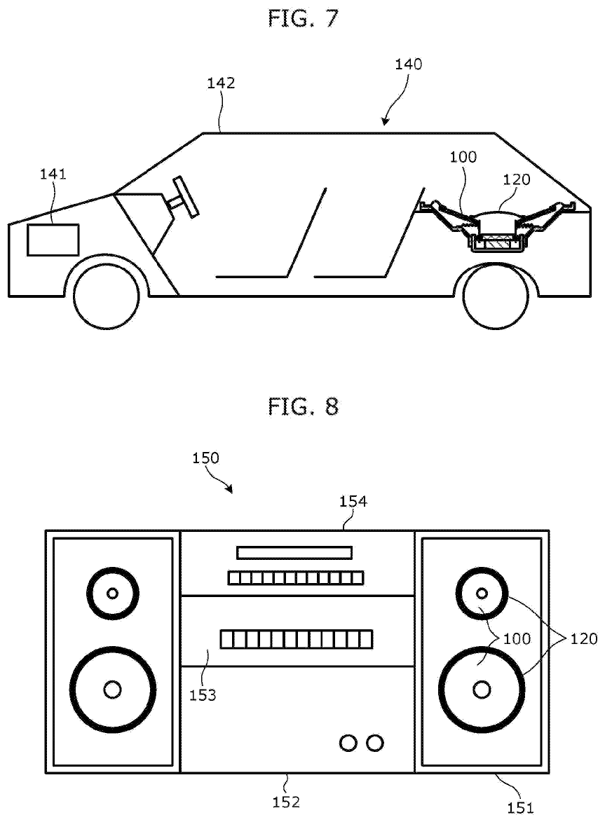

FIG. 7 is a cross-sectional view of car 140 which is an example of a mobile body to which loudspeaker device 120 including diaphragm 100 is attached. Car 140 includes loudspeaker device 120, which includes diaphragm 100, in the front panel, pillars, doors, and so on, aside from in a rear tray. Loudspeaker devices 120 are used as part of a car navigation system and/or car audio system. Car 140 includes driving means 141, and loudspeaker devices 120 travel together with car body 142 that functions as a casing that houses loudspeaker devices 120.

With loudspeaker device 120 that includes diaphragm 100, even if moisture such as rain or mud flows from car 140, the high water repellency of diaphragm 100 prevents adhesion of water, thereby preventing water from seeping into diaphragm 100. Therefore, the high acoustic performance of loudspeaker 120 can be maintained.

It should be noted that the present disclosure is not limited to the above-described embodiments. For example, other embodiments that can be realized by arbitrarily combining structural elements or removing some structural elements described in the present Specification may be embodiments of the present disclosure. Furthermore, variations obtainable through various modifications to the above-described embodiments that can be conceived by a person of ordinary skill in the art without departing from the essence of the present disclosure, that is, the meaning of the recitations in the Claims are included in the present disclosure.

For example, in the method of manufacturing diaphragm 100, a sizing agent for adjusting the liquid permeability of diaphragm 100 which is the manufactured product may be added to the pulp slurry.

Furthermore, loudspeaker device 120 that includes diaphragm 100 may be included in an electronic device as illustrated in FIG. 8. FIG. 8 is a diagram illustrating another usage example of loudspeaker device 120 including diaphragm 100. Audio mini component system 150 will be described as one example of an electronic device that includes loudspeaker device 120 including diaphragm 100.

In mini component system 150, loudspeakers 120 are built into each of two enclosures 151. Furthermore, mini component system 150 includes amplifier 152 that includes an amplifying circuit for an electrical signal that is inputted to loudspeaker devices 120, tuner 153 that outputs a source signal to be inputted to amplifier 152, and compact disc (CD) player 154. In mini component system 150 which is an audio mini component system, a music signal inputted from tuner 153 or CD player 154 is amplified by amplifier 152, and sound is discharged by loudspeaker devices 120 based on the amplified signal. It should be noted that, aside from mini component system 150, examples of an electronic device include a car audio system or a portable audio device, video devices such as a liquid-crystal television, an organic electroluminescence (EL) display television, or the like, an information communication device such as a mobile phone, or the like, and computer-related devices, and so on.

Further Information about Technical Background to this Application

The disclosure of the following patent application including specification, drawings, and claims is incorporated herein by reference in its entirety: Japanese Patent Application No. 2022-212078 filed on Dec. 28, 2022.

### INDUSTRIAL APPLICABILITY

Diaphragm 100 and loudspeaker device 120 including diaphragm 100 can be used in an electroacoustic transducer such as a microphone and the like.

1. A diaphragm manufacturing method comprising:
when a pulp slurry obtained after beating of a pulp exhibits anionic predominance, adding a fluoropolymer that is cationic into the pulp slurry to cause the fluoropolymer to be contained in the pulp; and
screening and shaping the pulp slurry into a diaphragm.

2. A diaphragm manufacturing method comprising:
when a pulp slurry obtained after beating of a pulp exhibits cationic predominance, adding a fluoropolymer that is anionic into the pulp slurry to cause the fluoropolymer to be contained in the pulp; and
screening and shaping the pulp slurry into the diaphragm.

3. The diaphragm manufacturing method according to claim 2, wherein
adding a cationic fixing agent to the pulp slurry obtained after beating of the pulp, before the adding of the fluoropolymer that is anionic.

4. The diaphragm manufacturing method according to claim 1, further comprising:
adding a paper strengthening agent to the pulp slurry, before the adding of the fluoropolymer that is cationic.

5. The diaphragm manufacturing method according to claim 2, further comprising:
adding a paper strengthening agent to the pulp slurry, after the adding of the fluoropolymer that is anionic.

6. The diaphragm manufacturing method according to claim 1, further comprising:
adding, to the pulp slurry, at least one of: long fiber pulp; recycled cotton fiber and recycled synthetic fiber that are hard resin coated; glass fiber; acrylic fiber; polyolefin fiber; polyester fiber; aramid fiber; or liquid-crystal polymer fiber.

7. The diaphragm manufacturing method according to claim 2, further comprising:
adding, to the pulp slurry, at least one of: long fiber pulp; recycled cotton fiber and recycled synthetic fiber that are hard resin coated; glass fiber; acrylic fiber; polyolefin fiber; polyester fiber; aramid fiber; or liquid-crystal polymer fiber.

8. The diaphragm manufacturing method according to claim 1, wherein
the diaphragm obtained after the screening and shaping of the pulp slurry is not impregnated with water repellent.

9. The diaphragm manufacturing method according to claim 2, wherein
the diaphragm obtained after the screening and shaping of the pulp slurry is not impregnated with water repellent.

10. The diaphragm manufacturing method according to claim 1, further comprising:
adding a sizing agent to the pulp slurry.

11. The diaphragm manufacturing method according to claim 2, further comprising:
adding a sizing agent to the pulp slurry.

12. The diaphragm manufacturing method according to claim 1, wherein
the fluoropolymer that is cationic includes a perfluoroalkyl terminal including at least 1 and at most 6 carbon atoms.

13. The diaphragm manufacturing method according to claim 2, wherein
the fluoropolymer that is anionic includes a perfluoroalkyl terminal including at least 1 and at most 6 carbon atoms.

14. The diaphragm manufacturing method according to claim 12, wherein
the fluoropolymer that is cationic is an acrylic resin having a nitrogen-containing cationic group.

15. The diaphragm manufacturing method according to claim 13, wherein
the fluoropolymer that is anionic is an acrylic resin having an anionic group.

16. A diaphragm comprising:
a pulp in which an acrylic resin is contained, the acrylic resin including a perfluoroalkyl terminal including at least 1 and at most 6 carbon atoms.
